(19) United States
(12) Patent Application Publication
(10) Pub. No.: US 2005/0038691 A1
(43) Pub. Date: Feb. 17, 2005

(54) Automatic identification based product defect and recall management

(76) Inventor: Suresh Babu, Los Altos, CA (US)

Correspondence Address: KENYON & KENYON (SAN JOSE), 333 WEST SAN CARLOS ST., SUITE 600, SAN JOSE, CA, 95110, US

(21) Appl. No.: 10/951,841

(22) Filed: Sep. 27, 2004

Related U.S. Application Data
(63) Continuation of application No. 10/776,619, filed on Feb. 12, 2004.
(60) Provisional application No. 60/483,903, filed on Jul. 2, 2003.

(51) Int. Cl. G06F 17/60

(52) U.S. Cl. 705/9; 705/1

(57) ABSTRACT

A computerized recall management tool permits an organization to recognize and proactively manage events that can indicate a need to initiate a product recall. Product performance data often is made available to an organization through automatic identification technologies. The recall management tool may include modules to recognize patterns of product defects from product performance data, to model an extent to which a product defect may proliferate throughout its distributed products, to alert operators when such patterns are detected, to manage regulatory reporting events and other notification milestones and to manage a recall itself.

This application is a continuation-in-part of application Ser. No. 10/776,619, filed Feb. 12, 2004, which claims the benefit of priority to provisional application Ser. No. 60/483,903, filed Jul. 2, 2003, the disclosure of which is incorporated herein in its entirety.

### BACKGROUND

Product recalls are often an expensive exercise that companies must undertake due to issues of safety of life and the related liabilities. Common consumer experience is littered with examples of product recalls that are mismanaged. Product manufacturers traditionally are slow to respond to data that can suggest that defective products have been distributed within the products' market and should be recalled and often are ill-equipped to gather and organize data in a manner that is sufficient to respond to intense media scrutiny that can arise as a consequence of product performance. Moreover, manufacturers and distributors sometimes attempt to shift blame for performance of defective products on each other rather than remediate the problem. As a result, an inadequate response to release of defective products can destroy years of careful brand-building. By contrast, empirical evidence suggests that a firm can respond proactively in the face of defective products and survive without significant loss of good will.

Even the most well intentioned firm, however, encounters practical difficulties to recognize and respond to market events that warrant a recall. First, the firm may learn of product defects through a variety of different sources, for example, from consumers, service people, distributors and perhaps suppliers. Firms often deploy different groups of people to interface with these different sources, which may consider each product defect in isolation. Such fragmentation of effected partners and firm personnel may cause a firm to be slow to recognize that a product defect warrants a recall. Second, some firms are not institutionally equipped to proactively engage their partners—consumers, distributors, etc.—to notify them of a recall. Thus, firms may encounter these and other logistical hurdles that frustrate the firms' ability to respond proactively and perform a product recall.

What is needed is an effective solution that can predict diffusion patterns, be able to quickly estimate overall costs and damage, and provide the ability to contain the spread of defective products in the first place.

### BRIEF DESCRIPTION OF THE DRAWINGS

FIG. 1 a functional block diagram of a recall management system according to an embodiment of the present invention.

FIG. 2 is a functional block diagram illustrating processes undertaken by an early warning system according to an embodiment of the present invention.

FIG. 3 illustrates an exemplary distribution chain.

FIG. 4 is a functional block diagram of a notification system according to an embodiment of the present invention.

FIG. 5 is a functional block diagram of a recall operations module according to an embodiment of the present invention.

FIG. 6 is a flow diagram illustrating a recall operations method according to an embodiment of the present invention.

FIG. 7 is a flow diagram illustrating a recall operations method according to another embodiment of the present invention.

FIG. 8 is a functional block diagram of a defect resolution monitor according to an embodiment of the present invention.

FIG. 9 is a data flow diagram according to an embodiment of the present invention.

FIG. 10 is a functional block diagram of a product defect and recall management system that uses automatic identification technologies according to an embodiment of the present invention.

FIG. 11 is a functional block diagram of a common computing platform which may implement an embodiment of the present invention.

### DETAILED DESCRIPTION

Embodiments of the present invention provide a computerized tool, a recall management system, to permit a firm to recognize and proactively manage a product recall. The tool, called a ‘recall management system’ herein, includes modules to recognize patterns of product defects from product performance data, to alert operators when such patterns are detected, to manage regulatory reporting events and other notification milestones and to manage a recall itself.

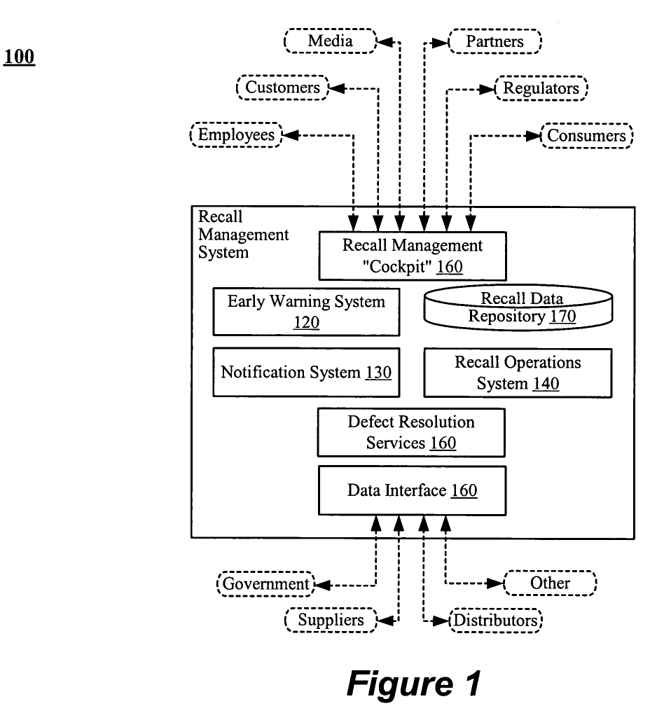

FIG. 1 is a functional block diagram of a recall management system (RMS) according to an embodiment of the present invention. The recall management system 100 may include a recall management ‘cockpit’ 110, an early warning system 120, a notification system 130, a recall operations system 140, a defect resolution services system 150 and a data interface system 160. The recall management system 100 also may include a recall data repository 170 to manage data regarding the recall.

The cockpit 110 may govern access to various recall reporting and recall services operations maintained by the RMS 100. As shown in FIG. 1, the cockpit 110 may maintain communications with system users from a variety of different audiences (e.g., employees, customers, media, etc.). Members of one audience may be granted access to different recall services or different reporting mechanisms of the RMS 100 than members of other audiences. Thus, the cockpit 110 may authenticate system users and govern their access to various facets of the RMS 100.

The early warning and assessment system (EWA) 120 manages data from a variety of sources in a product distribution chain and identifies product defect trends therefrom. The EWA system 120 may manage links to backend system to gather and analyze data. When a potential defect is identified, the EWA system 120 may model potential spread and extent of defective products within its distribution chain.

The notification system 130 may manage compliance with reporting requirements that may be imposed by regulatory sources and others. Thus, it generates reporting data according to templates that are appropriate for the entity that receives them. The notification system 130 also may manage reporting milestones to ensure that the system generates timely reports according to regulatory requirements.

The recall operations system 140 may manage the recall itself. It may provide operational capabilities such as returns management, repair management and service management, which help manage repair or replacement of possibly defective products from various entities in the product distribution chain. The recall operations system 140 also may provide functionality to permit these entities to determine whether the products they hold are subject to the recall and to provide information to integrate them into the recall process.

The defect resolution system 150 may interface with other entities in an enterprise management system (not shown) to remediate problems that are suspected to have caused the detected defect. Thus, the defect resolution system 150 can cause existing processes of the product manufacturer to be amended or enhanced to detect future defects before they enter the product's distribution chain.

The data interface unit 160 may solicit product defect data from various entities in the product's distribution chain. As noted, these can include various members from with the manufacturer's company itself, from suppliers and distributors and from other non-institutional sources such as customers, regulators, consumer product safety organizations, etc.

The recall data repository 170 represents storage to house various data structures being used by the RMS 100 generally. As such, it may include product performance data from which product defects may be identified, recall operations data to monitor performance of the recall, recall performance data that may be included in recall reports which are published to regulators, the media or other organizations.

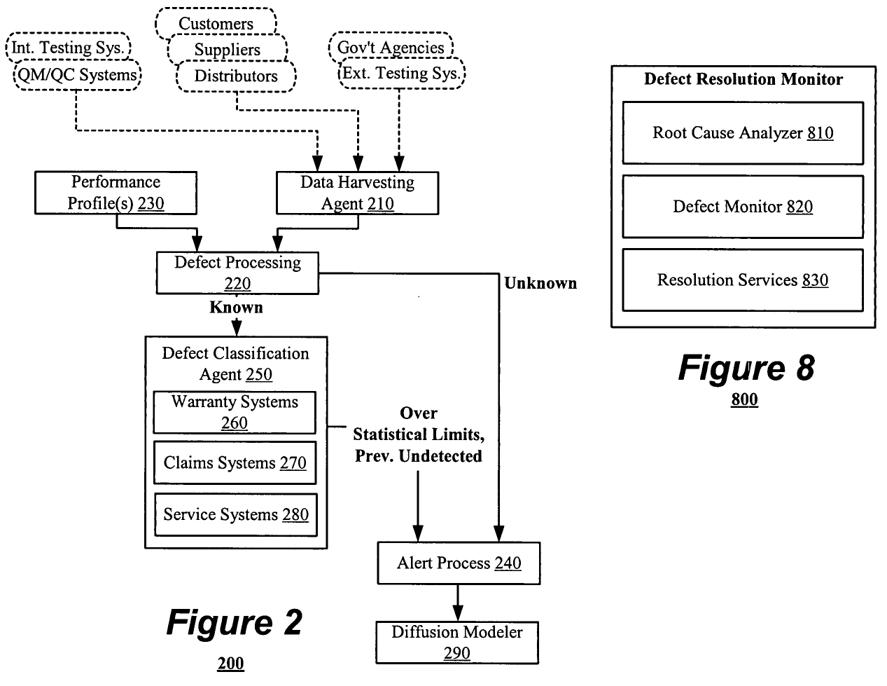

FIG. 2 is a functional block diagram illustrating processes undertaken by the EWA system 200 according to an embodiment of the present invention. There, a data harvesting agent 210 collects product performance data from a variety of sources both internal and external to the company that manufactures the product. Exemplary internal sources include internal testing systems and quality control or quality management systems. Exemplary external sources include data from customers, suppliers and distributors, for example. External sources also may include sources that are not members of the product distribution chain, including possibly governmental agencies or external testing services. The data harvesting agent 210 may collect data from one or more of these sources and populate data structures according to a variety of performance dimensions.

A defect processing agent 220 may compare the actual performance data collected by the harvesting agent 210 with one or more performance profiles 230 for the product. The performance profiles define performance benchmarks for the product; if actual product performance falls below such benchmarks, the product can be considered defective. If the defect processing agent 220 identifies a previously unknown defect, it may engage an alert process 240. If the defect processing agent 220 identifies a known defect, it may engage a defect classification agent 250. In so doing, the defect processing agent 220 may engage one or more product management systems commonly found in enterprise management applications, including warranty management system 260, claims system 270 and service systems 280. The defect classification agent 250 also may determine the extent of the defects within distributed products. For example, warranty systems 260 and the like may indicate the onset of product defects, the geographic distribution of defective products and the like. As a result, the defect classification agent 250 may determine whether the defect type identified is appearing in product line with a frequency that is either within or in excess of statistical limits. If the frequency with which a particular defect occurs in a product line exceeds a predetermined statistical limit, the defect classification agent 250 may engage the alert process 240. Similarly, if the defect classification agent 250 determines that the defect was previously undetected, it may engage the alert process.

According to an embodiment of the present invention, the alert process 240 determines whether the detected defect raises issues sufficient to merit a recall. Thereafter, the EWA system 200 may perform product diffusion modeling to estimate the extent of the defect in other products that have been manufactured, distributed and/or sold. The EWA 200 may store data representing a distribution chain for the product at issue. Based upon information regarding defects detected for the product, a diffusion modeler 290 may estimate an extent to which defective products have propagated through the distribution chain.

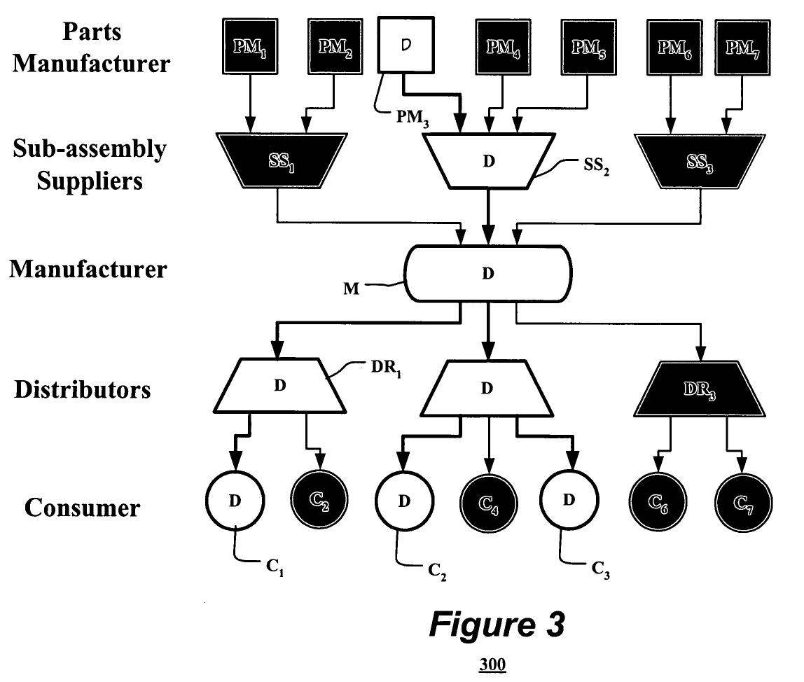

FIG. 3 illustrates an exemplary distribution chain for a hypothetical product. In this example, the distribution chain is composed of many levels including parts manufacturers, sub-assembly manufacturers, manufacturers, distributors and consumers. Although this example illustrates only one layer per level, this need not always be the case. For example, for many products, it is common to provide multiple layers of distributors before a manufactured product reaches an end consumer. The example of FIG. 3, however, is sufficient to illustrate the principles of the distribution modeling process used by the alert process 240.

In the example of FIG. 3, parts manufacturers PM1 and PM2 supply component parts to a sub-assembly supplier SS1. Parts manufacturers PM3-PM5 supply component parts to sub-assembly supplier SS2 and parts manufacturers PM6 and PM7 supply component parts to sub-assembly supplier SS3. Each of the sub-assembly suppliers SS1-SS3 supply sub-assemblies to a manufacturer M. The manufacturer M integrates the sub-assemblies into a completed product and forwards the completed product to distributors DR1-DR3. Distributor DR1 sells products to consumers C1 and C2. Distributor DR2 sells products to consumers C3-C5 and distributor DR3 sells products to consumers C6 and C7.

Consider an example where it is determined that parts manufacturer PM3 likely supplied defective component parts during a three month period. Product diffusion modeling may permit the alert process 240 to estimate the propagation of the defective component parts through its distribution chain. PM3 distributed component parts to sub-assembly supplier SS2. Sub-assemblies that included the defective component may have been supplied to the manufacturer M during some identifiable time period. Products resulting therefrom may have been delivered to distributors DR1 and DR2 and further distributed to consumers C1, C3 and C5. Thus, by modeling flow of products through the distribution chain, the alert process 240 may estimate the actors within the distribution chain that are most likely to have handled (or still hold) defective products.

Distribution modeling can provide information that helps to develop an estimate of the processes that may be required to perform a recall, if one is determined to be appropriate. For example, product diffusion modeling may indicate that defective products are confined to a predetermined geographical region, how many defective products may have been sold, who may have purchased defective products, which distributors may still hold defective products in their inventory and the like. In the foregoing example, distributors DR1 and DR2 and their customers might be clustered in an identifiable region of the United States. Accordingly, diffusion modeling may identify not only the extent to which defective products have proliferated throughout a distribution chain but also may provide a basis from which to plan a recall.

Of course, diffusion modeling merely provides an estimate of product migration that may occur in a distribution chain. The estimate may be refined by information provided by alternative data sources, such as service centers and the like. For example, although consumers may purchase a product from a distributor in one geographic region, they may move products to other geographic regions through normal use of those products. The products may be submitted to repair centers in the different geographic regions, which may log the products by a serial number or other identifier. By propagating the serial numbers back to a manufacturer or distributor, the manufacturer/distributor may revise the estimate provided by the diffusion model to obtain a more reliable indicator of product migration. Similarly, exchanges among distributors (for example, a transfer of inventory between two regionally separated distributors) may enhance the diffusion model.

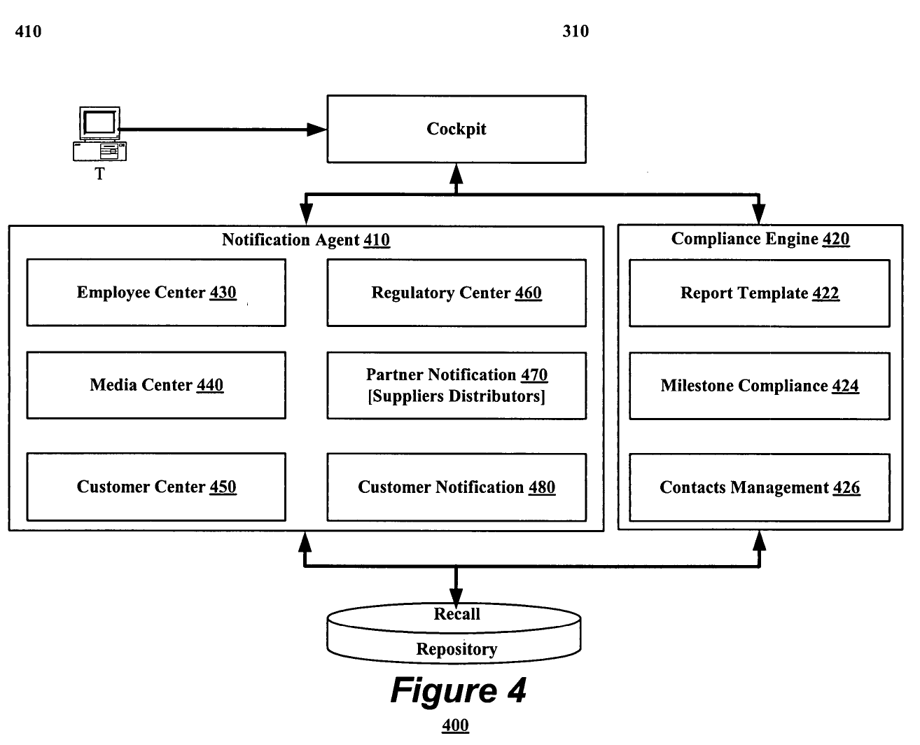

FIG. 4 is a functional block diagram of a notification system 400 according to an embodiment of the present invention. The notification system 400 may include a notification agent 410 and a compliance engine 420. The notification agent 410 may act as a data management center to organize and present data regarding an ongoing recall. As noted, the notification system 400 may tailor presentation of data to suit the needs of different audiences. Thus, the notification agent 410 may include modules 430-460 that maintain an ‘employee center,’ a ‘media center,’ a ‘customer center’ and a ‘regulatory center.’ When the cockpit opens a session with a new terminal T, the system may classify the terminal's operator and engage one of the centers as described above.

The notification agent 410 also may generate recall notifications proactively. For example, the RMS may be provided in a system that maintains records for partners in the distribution chain and perhaps even end consumers. When it is determined to launch a recall, partner notification units 470 and consumer notification units 480 may initiate communication with those partners and consumers. Commonly, partner databases and consumer databases store mailing addresses, e-mail addresses and/or telephone numbers for each contact. Partner and consumer notification units 470, 480 may engage other system (not shown) to generate automated notifications to those contacts. For example, the notification units 470, 480 may engage an e-mail server to transmit recall notifications by e-mail. Alternatively, the notification units 470, 480 may engage automated telephonic voice response systems to notify contacts telephonically.

Again, the partner and consumer notification units 470, 480 each may tailor the presentation of the recall notification to suit the needs of the individual recipient. For example, a recall notification to an end consumer may include information regarding remediation of the defective product—procedures explaining how to replace or repair the product. A recall notification to a distributor by contrast may include information identifying which batches are likely to contain defects and which are not. From the notification, the distributor might be able to determine whether it holds any defective products in its inventory and withhold them from further distribution. It also could determine which products in its inventory are unlikely to contain the defects and can be distributed or sold.

Each of the modules 430-480 of the notification agent 410 may have access to the recall depository to gain access to substantive data regarding the recall and its progress.

In an embodiment, the notification system may include a compliance engine 420 to ensure compliance with regulatory agencies and the like during management of the recall. In many industries, firms are subject to specific requirements regarding the reporting of defective products. Indeed, many firms are required to submit product defect data to specific regulatory agencies in specific formats according to a predetermined timetable. The compliance engine 420 may manage this process in the RMS.

The compliance engine 420 may include modules that define regulatory reporting procedures to be undertaken. A report template unit 422 may identify the form and content of reports that are to be made. A milestone compliance unit 424 may identify when reports are to be made. A contacts management unit 426 may identify to whom the reports are to be made. During operation, the compliance engine 420 periodically refers to the milestone compliance unit 424 to determine whether a report has come due. If so, the compliance engine may refer to the report template to determine what data needs to be provided in the next report. The compliance unit may retrieve the required data from the recall repository and format the data according to parameters identified in the report template 422. The compliance unit may transmit the report to a recipient identified in the contact management unit 426.

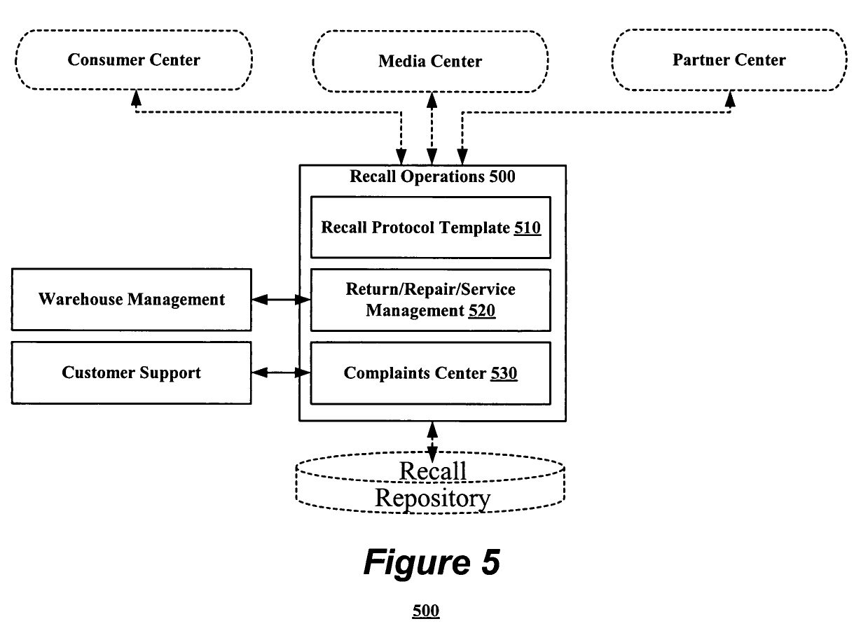

FIG. 5 is a functional block diagram of a recall operations module 500 according to an embodiment of the present invention. The recall operations module 500 provides support for the recall itself. It can help manage returns or service of distributed products that may include product defects. According to an embodiment, the recall operations module may include a recall protocol template 510, returns/repair/service management unit 520 and a complaints center 530. The recall protocol template 510 may provide a definition of recall procedures that govern recall of a given product. Intuitively, one may expect that recall procedures for automobiles may differ from recall procedures for other products, such as medications or office products. The recall protocol template 510 establishes how a recall of the defective product may occur.

A returns/repair/service management unit 520 may regulate the processes defined in the recall protocol template. For example, in the cause of an automobile defect where defective automobiles are to be submitted to service stations for repair, consumers or technicians may be required to obtain a pre-authorization before a manufacturer will agree to compensate the technician for remedial services. The returns/repair/service management unit 520 may authenticate a given automobile (for example, by verifying that the auto's vehicle identification number is subject to recall) and providing an electronic tracking number to the technician that authorizes the technician to perform remedial services pursuant to the recall.

The complaints center 530 may provide an automated process through which recall participants may voice concerns regarding the recall or its procedures. The complaints center 530 may establish a session with participants' terminals to collect feedback. Data from the participants may be stored in the recall repository for later use. Further, the return operations system 510 may engage a customer support center 540 to process the collected feedback. Customer support centers 540 conventionally are provided by product manufacturers and other firms as part of customer relationship management applications (colloquially, “CRM”) in enterprise management systems. Thus, the recall operations system 510 may be integrated with such CRM applications to facilitate the recall operations.

FIG. 6 is a flow diagram illustrating a procedure that may govern a product recall according to one embodiment of the present invention. The method may begin when a consumer establishes a session with the recall operations system 610 of FIG. 6. In the embodiment, the method may capture product identification information (box 610) and, with reference to recall repository, determine whether the consumer's product is subject to the recall (box 620). If so, the method may generate a tracking number for the recall (box 630). The method also may transfer to the consumer a notification of the procedures to be followed to repair or replace the product as well as information regarding what is known about the product's defects and possible consequences that may occur from continued use of the product (box 640). The method may require that the consumer acknowledge receipt of the notices and may record the consumer's acknowledgment in the recall repository (box 650).

In some embodiments, the recall procedures may compel consumers to destroy the products they hold and purchase replacements. Thus, the recall operations system 610 may provide an electronic certificate to the consumer entitling the consumer to a free replacement product (box 660). In another embodiment, not shown, the recall operations system 610 may enter a transaction in a warehouse management system 550 (FIG. 5), which may cause a replacement product to be shipped to the consumer.

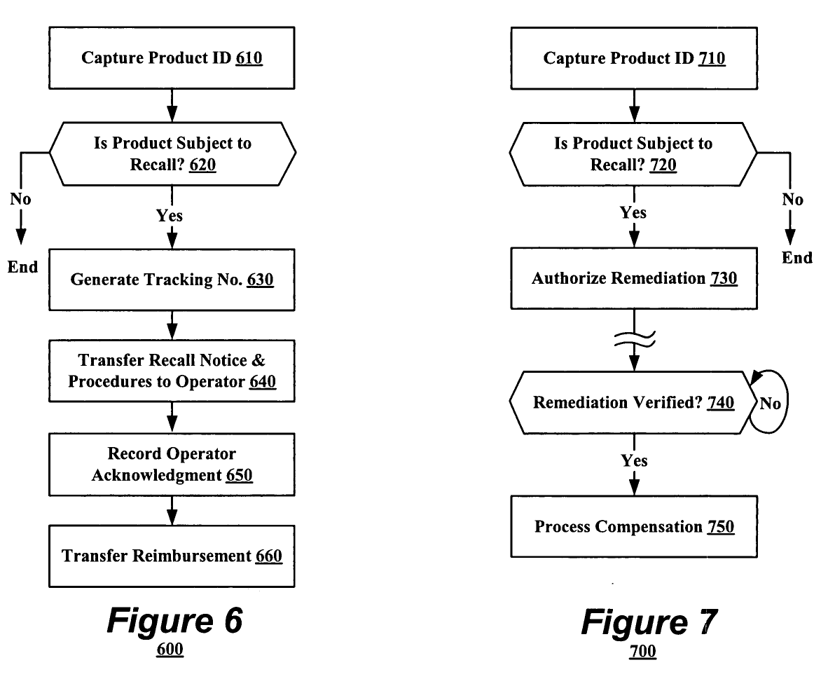

FIG. 7 illustrates a method 700 that may occur when a consumer presents a product at a repair facility for remediation according to an embodiment of the present invention. This embodiment may be appropriate when a service provider establishes a communication session with the recall operations system. According to the method, a system may capture product identification information (box 710) and determine whether the product is subject to a recall (box 720). If so, the method may signal to the service provider's terminal that remediation is authorized (box 730). Sometime thereafter, either during the same session or pursuant to another session, the service provider may indicate that the remediation has been performed. The method may engage verification procedures and, upon successful verification, may process compensation to the service provider (boxes 740, 750).

FIG. 8 is a block diagram of a defect resolution module 800 according to an embodiment of the present invention. The defect resolution module 800 provides a tool that can help an organization to revise their operations to guard against future occurrences of the product defect that gives rise to a recall. The defect resolution module 800 may include a root cause analyzer 810, a defect monitor 820 and a resolution services module 830.

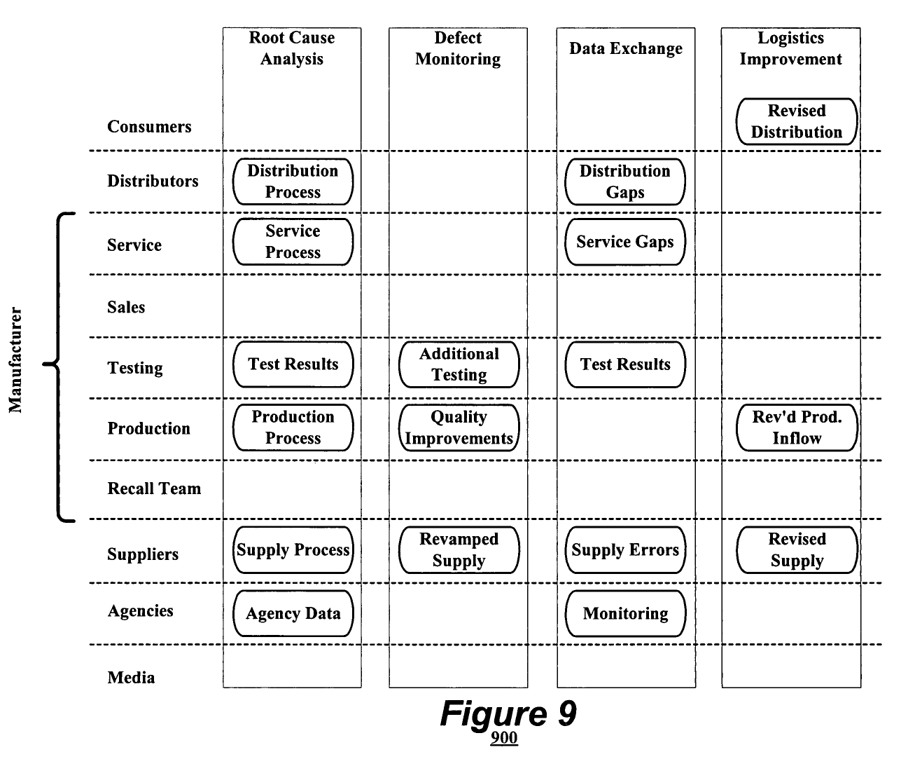

The root cause analyzer 810 provides a tool to identify a source of the defect within the operational framework of the organization. In so doing, the root cause analyzer 810 may gain access to much of the same data as the early warning system 200 (FIG. 2) and to the distribution modeling performed by that system. In the data flow diagram 900 of FIG. 9, therefore, the root cause analyzer is shown having access to data sources from distributors, service personnel, manufacturing testing divisions and manufacturing production divisions, suppliers and agency sources. The root cause analyzer 810 can trace migration of a defective product or components through the distribution chain and identify likely sources of the defect.

The defect monitor 820 provides services to monitor production process and product testing facilities, both those that were in place prior to identification of a product defect and those that may be initiated in response to the defect. Even if the root analyzer cannot identify a single likely source of a product defect, the defect monitor 820 may gather data regarding component and product performance and testing data therefor.

The resolution services module 830 provides a feedback path from the data harvesting functions of the root cause analyzer 810 and the defect monitor 820 to the operations of the organization and its relationships perhaps with other entities in the distribution chain. As such, the resolution services module 830 may include a first component to provide data exchange services with other members of the distribution chain and the public (e.g., distributors, suppliers, service technicians and governmental agencies). The resolution services module 830 also may include a component to identify processes within the distribution chain that are operating outside of defined operating requirements. For example, if the organization determined as a result of the recall analysis that delivery timetables for distributors must meet a predetermined schedule and the actual delivery timetables were longer than required, the resolution services module would report these failures both within the organization as well as to the distributors that are not performing adequately. Thus the defect resolution services module 800 can initiate remedial action based on data it collects regarding performance of the distribution chain. If a part from a parts manufacturer is defective, the RSM 830 is activated to track the performance of the improved product or to procure the part from other suppliers with performance feedback and required parts data exchange.

The functionality of a standard product defect and recall management (PDRM) system may be increased through the use of automatic identification (Auto-ID) technologies. Auto-ID is the broad term given to a host of technologies that may be used to help automated identification and data capture of objects. The Auto-ID systems may be used to increase efficiency, reduce data entry errors, increase accuracy of data capture, and free up staff to perform more value-added functions. A host of technologies fall under the Auto-ID umbrella, including bar codes, smart cards, voice recognition, biometric technologies (such as the genetic identification of agricultural products), optical character recognition (OCR), radio frequency identification (RFID), and others. Auto-Id technologies allow an unprecedented supply chain visibility, and asset tracking, tracing, and management.

The PDRM may use Auto-ID technologies to greatly increase the efficiency of a recall. Auto-ID tags may be attached to either a manufactured product or to the components used to build that product. The Auto-ID tags may be passive tags, such as bar codes, OCR tags, or passive antenna that associate a product with an identifier. The identifier may then be associated with data stored in a database by the manufacturer. Alternatively, the Auto-ID tags may have an active element, such as a microprocessor or memory, to allow the data to be stored with the product. The data may include product performance data to alert the manufacturer to the need for a recall or genealogy data, such as parts manufacturers, sub-assembly suppliers, and distributors, to allow the recall to be targeted towards those products in need of recall. The PDRM may use adequate privacy safeguards that strip away customer specific data. Additionally, the Auto-ID tags may include sensors that allow the state of the product to be determined.

The PDRM may also use Auto-ID technologies to increase the efficiency of defect resolution as well. Once the root cause analyzer has determined the cause of the product defect, the defect monitor 820 may use the Auto-ID technology to trace back to the location on the distribution chain where the root cause occurs, and from their down the distribution chain to the ensuing defects. Having tracked the defects, the resolution services 830 may transmit data necessary for curing the defect to appropriate parties in the distribution chain.

In one example, auto tires may be equipped with Auto-ID tags, which specify the tire's unique ID, the manufacturer, date and location of manufacture, maximum and minimum inflation pressures, the vehicle equipped with the tire, and other details. Additionally, a simple sensor chip may also be built into the tires to track tire pressures and wear on treads to specify the condition of the tire. If dealers providing service or accident investigators notice tire defects, the sensor readout and the auto-id of the tire may be electronically transferred by the dealer to the tire manufacturer. Aggregating information from different sources and intelligent analysis of the data could alert the manufacturer to systematic problems with the certain plant or batch or make and the type of defect. The sensor data eliminates the uncertainty about the contributing factors in assessing the nature of the manufacturing defect.

If the decision to recall the tires is made, the auto-id trail makes the task of notifying the automakers and the authorities considerably easier. The compliance engine may make the necessary checks for regulatory compliance. The tire manufacturer can electronically communicate the nature and severity of the tire defect, batches affected, times of manufacture, distribution status, proposed remedy, cost of the remedy, and so on, to the automakers, dealers, and tire distributors. Using the defect information, the dealers or tire distributors may spot defective tires and advise customers of next steps. Also, the dealers can coordinate with the automaker and the tire manufacturer to issue recall notices based on the location and distribution information suggested by the solution. Once the product defect is identified, the parallel process of correcting the defects and monitoring quality can be initiated with the information provided by the sensors and auto-ids. The quality management process at the location or plant suggested by the aggregated information can be investigated for corrective action. Also, testing can be increased to make sure such defects do not reoccur. The location, time, and batch of manufacturing may also indicate if a particular raw material supplier is contributing to the defective product.

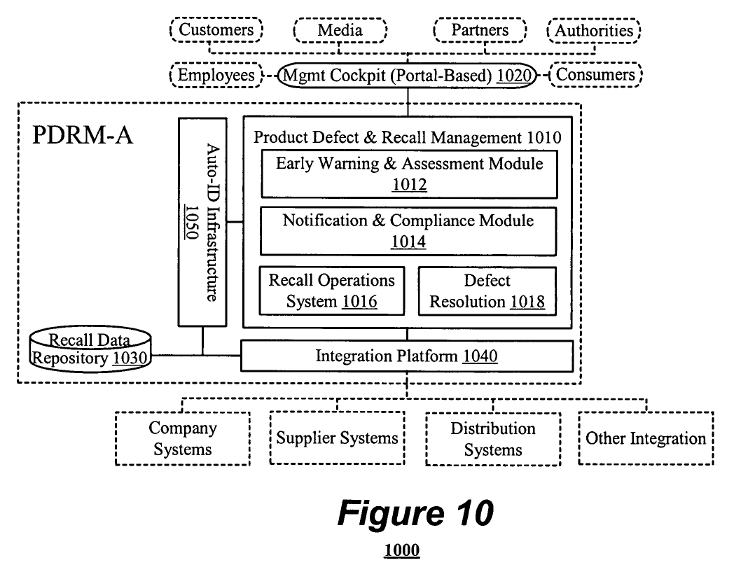

FIG. 10 illustrates in a functional block diagram one embodiment of a PDRM system using Auto-ID technologies. The PDRM system 1010 may have core functional modules that include the early warning and assessment system 1012, the notification and compliance system 1014, the recall operations system 1016, and the defect resolution services 1018. These core modules are supported by the management cockpit 1020, the data repository 1030, the integration platform 1040, and the Auto-Id infrastructure 1050. The management cockpit 1020 may be a portal-driven interface that provides the designated recall management team an integrated view into the entire recall process to manage the process efficiently. The data repository 1030 warehouses the massive amounts of data received or retrieved to analyze potential recall scenarios, and data about the actual recall process, once that is launched. The repository 1030 will also maintain links to other systems where data is stored. The integration platform 1040 provides the cross-system access and process control to make the handling of the disjointed defect handling & recall process possible. The Auto-Id infrastructure 1050 may allow the sophisticated deployment and leverage of auto-id technologies at the enterprise level. The Auto-Id infrastructure 1050 may feature a highly scalable auto-id platform supporting hardware independent, bidirectional protocols, and offers support for a wide range of hardware and software applications utilizing auto-id technologies.

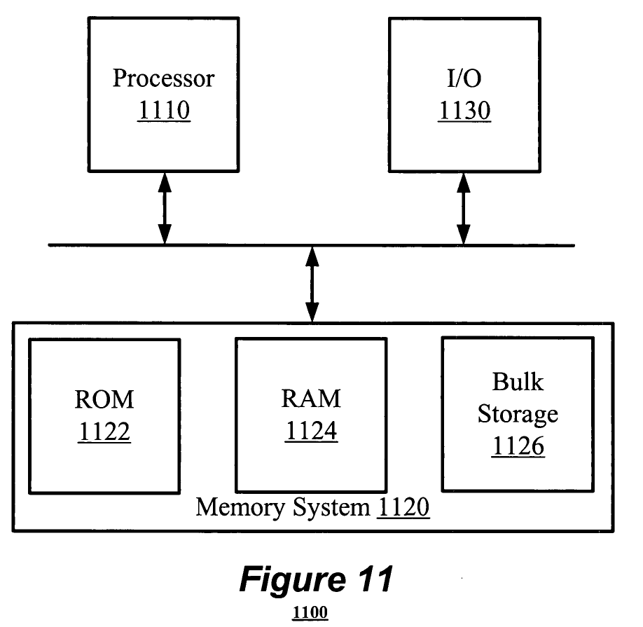

The foregoing embodiments may provide a software-implemented system. As such, these embodiments may be represented by program instructions that are to be executed by a server or other common computing platform. One such platform 1100 is illustrated in the simplified block diagram of FIG. 11. There, the platform 1100 is shown as being populated by a processor 1110, a memory system 1120 and an input/output (I/O) unit 1130. The processor 1110 may be any of a plurality of conventional processing systems, including microprocessors, digital signal processors and field programmable logic arrays. In some applications, it may be advantageous to provide multiple processors (not shown) in the platform 1100. The processor(s) 1110 execute program instructions stored in the memory system. The memory system 1120 may include any combination of conventional memory circuits, including electrical, magnetic or optical memory systems. As shown in FIG. 11, the memory system may include read only memories 1122, random access memories 1124 and bulk storage 1126. The memory system not only stores the program instructions representing the various methods described herein but also can store the data items on which these methods operate. The I/O unit 1130 would permit communication with external devices (not shown).

Several embodiments of the present invention are specifically illustrated and described herein. However, it will be appreciated that modifications and variations of the present invention are covered by the above teachings and within the purview of the appended claims without departing from the spirit and intended scope of the invention.

1. A computerized recall management system, comprising:
an automatic identification infrastructure, using automatic identification technologies to track product performance data;
an early warning system, responsive to the product performance data, to detect a pattern of product defects therefrom and generate an alert;
a recall operations system, storing data representing procedures to be followed to process a recall of defective products;
a recall repository to store data representing performance of the recall; and
a notification system, storing a report template representing recall reporting requirements, to generate a report from data of the recall repository according to parameters defined in the report template.

2. The recall management system of claim 1, wherein the automatic identification technologies are one of a group including bar codes, smart cards, biometric technologies, optical character recognition, or radio frequency identification.

3. The recall management system of claim 1, wherein the automatic identification infrastructure uses passive identification tags.

4. The recall management system of claim 1, wherein the automatic identification infrastructure uses identification tags with an active element.

5. The recall management system of claim 1, wherein the automatic identification infrastructure uses identification tags at a component level.

6. The recall management system of claim 1, wherein the automatic identification infrastructure uses identification tags at a product level.

7. The recall management system of claim 1, wherein the automatic identification infrastructure has adequate privacy safeguards to redact customer specific data.

8. A method of detecting product defects, comprising:
gathering product performance data using automatic identification technologies,
comparing the performance data to performance benchmarks,
when the comparison identifies an instance of product performance that fails a benchmark, determining whether the instance relates to a previously undetected product defect,
if so, generating an alert.

9. The method of claim 8, wherein the automatic identification technologies are one of a group including bar codes, smart cards, biometric technologies, optical character recognition, or radio frequency identification.

10. The method of claim 8, wherein the automatic identification technologies use passive identification tags.

11. The method of claim 8, wherein the automatic identification technologies use identification tags with an active element.

12. The method of claim 8, wherein the automatic identification technologies have adequate privacy safeguards to redact customer specific data.

13. Computer readable medium having instructions stored thereon that, when executed by a processing device, causes the device to:
gathering product performance data using automatic identification technologies,
comparing the performance data to performance benchmarks,
when the comparison identifies an instance of product performance that fails a benchmark, determining whether the instance relates to a previously undetected product defect,
if so, generating an alert.

14. The medium of claim 13, wherein the automatic identification technologies are one of a group including bar codes, smart cards, biometric technologies, optical character recognition, or radio frequency identification.

15. The medium of claim 13, wherein the automatic identification technologies use passive identification tags.

16. The medium of claim 13, wherein the automatic identification technologies use identification tags with an active element.

17. The medium of claim 13, wherein the automatic identification technologies have adequate privacy safeguards to redact customer specific data.

18. A recall operations system comprising:
a recall protocol template storing definitions of recall procedures to be used with respect to an instance of a product recall,
a recall repository storing product data in part collected using automatic identification technologies to target the product recall and
a recall management agent, responsive to the recall protocol template, to:
authenticate individual participants of the recall based on the stored product data,
transfer to authenticated participants, recall tracking information and recall notification information, and
record authenticated participants' receipt of the recall notification information in the recall repository.

19. The recall operations system of claim 18, wherein the automatic identification technologies use passive identification tags.

20. The recall operations system of claim 18, wherein the automatic identification technologies use identification tags with an active element.

21. A recall resolution system comprising:
a root cause analyzer to determine a root cause of a product defect based on data representing the product defect;
a defect monitor to locate the root cause and ensuing defects on a distribution chain using automatic identification technologies to collect data representing the product defect; and
resolution services to transmit data regarding the root cause and product defect to appropriate parties on the distribution chain.

22. The recall resolution system of claim 21, wherein the automatic identification technologies use passive identification tags.

23. The recall resolution system of claim 21, wherein the automatic identification technologies use identification tags with an active element.
